(19) United States
(12) Patent Application Publication
(10) Pub. No.: US 2014/0120383 A1
(43) Pub. Date: May 1, 2014

(54) APPARATUS AND METHOD FOR HIGH POWER DENSITY POWER DISCHARGE FROM A BATTERY PACK

(71) Applicant: John Bradford Janik, Houston, TX (US)

(72) Inventor: John Bradford Janik, Houston, TX (US)

(21) Appl. No.: 13/660,577

(22) Filed: Oct. 25, 2012

(51) Int. Cl. H01M 10/50

(52) U.S. Cl. CPC H01M 10/5016
USPC 429/50; 429/120

(57) ABSTRACT

A method is disclosed for connecting batteries, the method including but not limited to clamping a hot battery terminal made of a first metal of a first battery cell to a cold battery terminal made of a second metal of a second battery cell, wherein the hot terminal has a lower conductivity than the hot terminal; sharing heat from the hot and cold terminal in the clamp; dissipating the heat from the hot and cold terminal in the clam; and providing a Higher power density from the batteries. An apparatus is disclosed for performing the method.

### BACKGROUND

1. Related Art

Electric vehicles powered by a battery pack are typically designed to deliver a relatively low horse power rating over a long period of time so that a person in an electric car can drive around town for a week or for a relatively long distance, for example 250 miles without recharging the battery pack. Thus, the off shelf rechargeable batteries are designed for this relatively low duty cycle.

2. Field of the invention

The present invention relates to dissipating power from a battery pack.

### SUMMARY OF THE INVENTION

A method is disclosed for connecting batteries, the method including but not limited to clamping a hot battery terminal made of a first metal of a first battery cell to a cold battery terminal made of a second metal of a second battery cell, wherein the hot terminal has a lower conductivity than the hot terminal; sharing heat from the hot and cold terminal in the clamp; dissipating the heat from the hot and cold terminal in the clam; and providing a higher power density from the batteries. An apparatus is disclosed for performing the method.

### BRIEF DESCRIPTION OF THE DRAWINGS

FIG. 1 is a schematic depiction of an illustrative operational environment for an illustrative embodiment;

FIG. 2 is a schematic depiction of a battery cell in a particular illustrative embodiment;

FIG. 3 is a schematic depiction of a high power density connection between battery cells operational environment for a particular illustrative embodiment;

FIG. 4 is a schematic depiction of a high power density connection between battery cells operational environment for an illustrative embodiment;

FIG. 5 is a schematic depiction of an illustrative embodiment of a high power density clamp; and

FIG. 6 is a schematic depiction of an illustrative embodiment of a bonded fin heat sink.

### DETAILED DESCRIPTION

In a particular illustrative embodiment, a rechargeable battery pack is provided to provide emergency back up power to a ship when an engine goes down. If engine power is lost on a ship while the ship is adjacent an oil rig, the ship may lose ability to maintain position and crash into the oil rig during the time before a second engine can be brought up and on line to replace the first engine that failed. In one particular scenario it is estimated that it takes 30 seconds for a second engine to be fired up and brought on line to replace the first engine. Thus, in a particular illustrative embodiment, during the 30 seconds of waiting for the second engine to come on line, the rechargeable battery pack provides 6000 horse power to an emergency power engine so that the ship does not lose steerage during the 30 second lapse between the first engine failing and the second engine coming on line.

Off the shelf rechargeable batteries are sometimes supplied with a spot welded foil tab to provide an electrical connection to each of the positive and negative terminals on the rechargeable batteries. The off the shelf spot welded batteries are suitable for delivering of relatively low horse power requiring a relatively low power density. The off the shelf spot welded batteries are not suitable for delivering the relatively high horse power over a short period of time requiring a relatively high power density. The foil tab accommodates close physical stacking of a plurality of adjacent battery cells in battery packs. The off the shelf configurations for the rechargeable batteries are not designed to deliver such a high power density such as 6000 horse power for 30 seconds and in fact will fail under such conditions. Thus, a high power density system and method are provided to utilized the off the shelf battery cells in a high power density application for emergency back up engines for ships.

In a particular embodiment, the battery cells are rechargeable lithium ion batteries. A lithium-ion battery (sometimes Li-ion battery or LIB) is a family of rechargeable battery types in which lithium ions move from the negative electrode to the positive electrode during discharge, and back when charging. Chemistry, performance, cost, and safety characteristics vary across LIB types. Unlike lithium primary batteries (which are disposable), lithium-ion electrochemical cells use an intercalated lithium compound as the electrode material instead of metallic lithium. Lithium-ion batteries are common in consumer electronics. The LIB types are one of the most popular types of rechargeable battery for portable electronics, with one of the best energy densities, no memory effect, and a slow loss of charge when not in use.

The three primary functional components of a lithium-ion battery are the anode, cathode, and electrolyte. The anode of a conventional lithium-ion cell is made from carbon, the cathode is a metal oxide, and the electrolyte is a lithium salt in an organic solvent. The most commercially popular anode material is graphite. The cathode is generally one of three materials: a layered oxide (such as lithium cobalt oxide), a polyanion (such aslithium iron phosphate), or a spinel (such as lithium manganese oxide). The electrolyte is typically a mixture of organic carbonates such as ethylene carbonate or diethyl carbonate containing complexes of lithium ions.^{[14]} These non-aqueous electrolytes generally use non-coordinating anion salts such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃).

Depending on materials choices, the voltage, capacity, life, and safety of a lithium-ion battery can change dramatically. Pure lithium is very reactive. It reacts vigorously with water to form lithium hydroxide and hydrogen gas. Thus, a non-aqueous electrolyte is typically used, and a sealed container rigidly excludes water from the battery pack. Lithium ion batteries are more expensive than NiCd batteries but operate over a wider temperature range with higher energy densities, while being smaller and lighter. They are fragile and so need a protective circuit to limit peak voltages. In one particular illustrative embodiment a battery cell is an LIB with a flat pouch body and foil connectors spot welded to the positive and negative terminals on the LIB body.

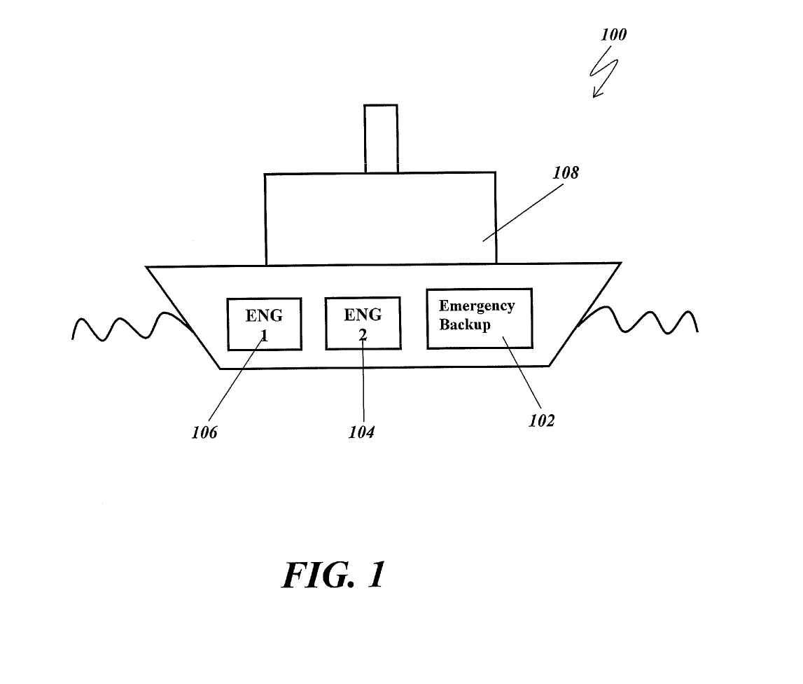

Turning now to FIG. 1, a ship 100 is shown carrying a first engine 106, a second engine 104 and an emergency backup system 102 in a particular illustrative embodiment. The emergency back up system provides 6000 horsepower of immediately available electrical energy. In particular embodiment, the emergency back up is activated to power the ship 100 and provide steerage when either the first or second engine goes down or fails to operate. The emergency back up system provides a high power density back up to power the ship for a brief period of time until the currently operating first or second engine goes down to power the ship until the other engine, second or first is ready to take over. In a particular embodiment, the emergency back up takes over from the failed engine for a period of about 30 seconds. During the emergency backup 30 second duty cycle the emergency back up system provides 6000 horsepower from electrical power stored in rechargeable batteries. In another illustrative embodiment, the emergency back up system provides substantially more horse power over a shorter period of time, e.g., 10,000 horsepower for 10 seconds. The energy back up system is configurable to accommodate varying power needs for varying durations according to the needs of an application.

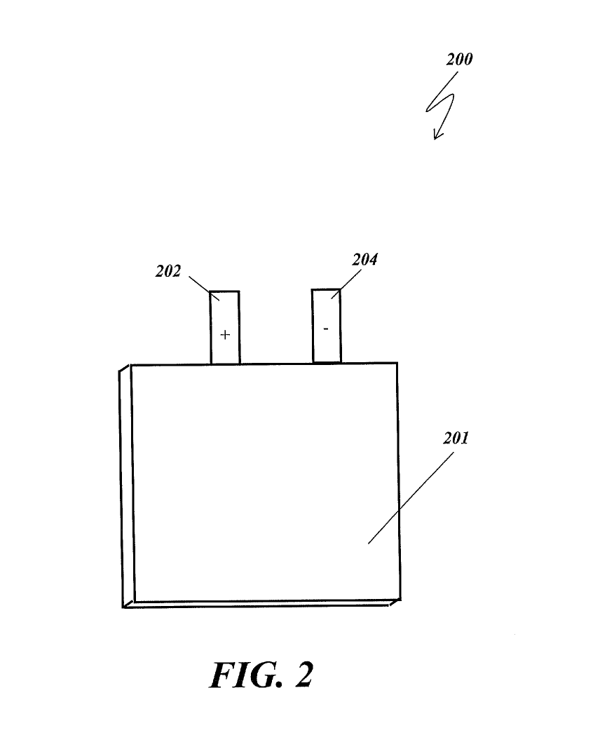

Turning now to FIG. 2, in a particular embodiment 200 the electrical energy for the emergency back up unit is stored in a bank of lithium ion modules connected in parallel. Each module is a combination of four battery cells 200 connected in series. The modules are then connected in parallel to provide a high power density output of 6000 horse power for 30 seconds. As shown in FIG. 2, the battery cell has a flat pack pouch body design having a roughly square side front and back sides 201 and relatively thin thickness 202. Connectors 202 and 204 are attached to the battery body to the battery cell positive and negative terminals respectively. In a particular illustrative embodiment, foil strips 202 and 204 are spot welded to the battery cell body. The foil strips act as an electrical connection to the positive terminal and the negative terminal for each battery. In a particular illustrative embodiment, a plurality of rechargeable battery cells are provided.

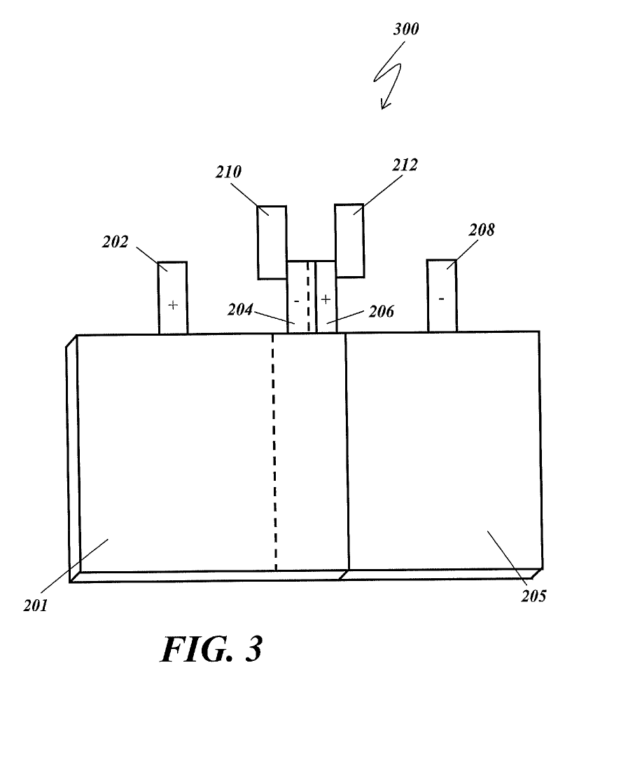

Turning now to FIG. 3, in a particular embodiment, the battery cells are electrically connected in series in groups of four to form a module. A plurality of these modules are electrically connected in parallel to form the combined output power. A high power density heat sink bus is provided to connect the battery cells in series is provided. Each rechargeable battery has a spot welded foil tab connected to each of positive output voltage terminal and the negative output voltage terminal. The negative output voltage terminal foil tab is made of tin plated aluminum and the positive output voltage terminal is made of copper. In a particular embodiment, the aluminum foil tab is less conductive thermally than the copper foil tab. In another particular embodiment, the aluminum foil tab is less conductive electrically than the copper foil tab.

Each rechargeable battery cell has a positive output voltage terminal and a negative output voltage terminal. Thus, in the module of four battery cells, the positive voltage output tab for the each rechargeable battery cells is connected to the negative output voltage terminal of another one of the four battery cells. For simplicity a single series connection between adjacent battery cells is depicted in FIG. 3. In an illustrative embodiment, where there are four battery cells in a module, the first battery cell has its positive terminal connected to the negative terminal of a second battery cell and its negative terminal connected to the positive terminal of a fourth battery cell. Similarly the second battery cell has its positive terminal connected to the negative terminal of a third battery cell and its negative terminal connected to the positive terminal of the first battery cell. Similarly the third battery cell has its positive terminal connected to the negative terminal of a fourth battery cell and its negative terminal connected to the positive terminal of the second battery cell. Similarly the fourth battery cell has its positive terminal connected to the negative terminal of the battery cell and its negative terminal connected to the positive terminal of the first battery cell.

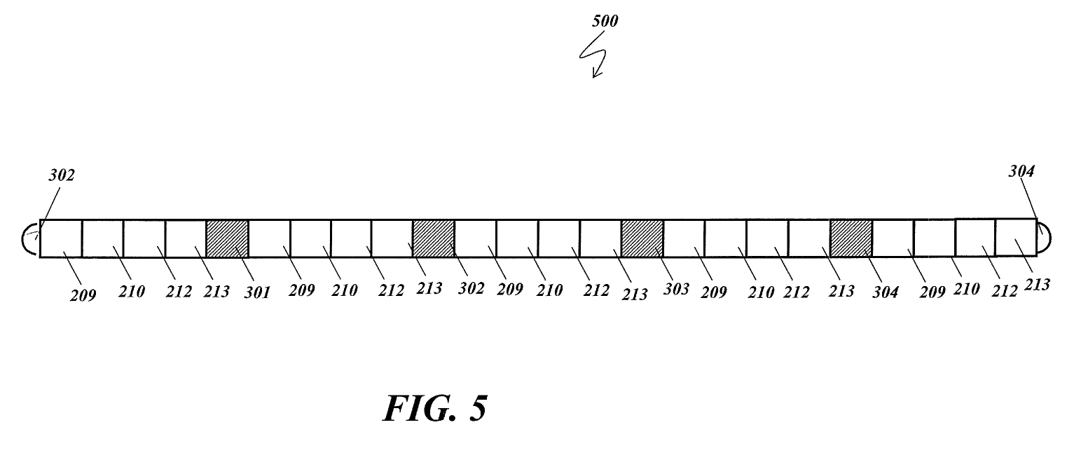

As shown in FIG. 3, the connections between battery cells are made by compressing a foil tab for a negative terminal 204 for a first battery and a foil tab for a positive terminal 206 in a second battery between conductive elements 210 and 212 in a segment of a heat sink electrical bus. The conductive elements in the heat sink electrical bus are grouped in to sets of four elements to form a segment of four elements. The segments separated by an insulator as shown in FIG. 5.

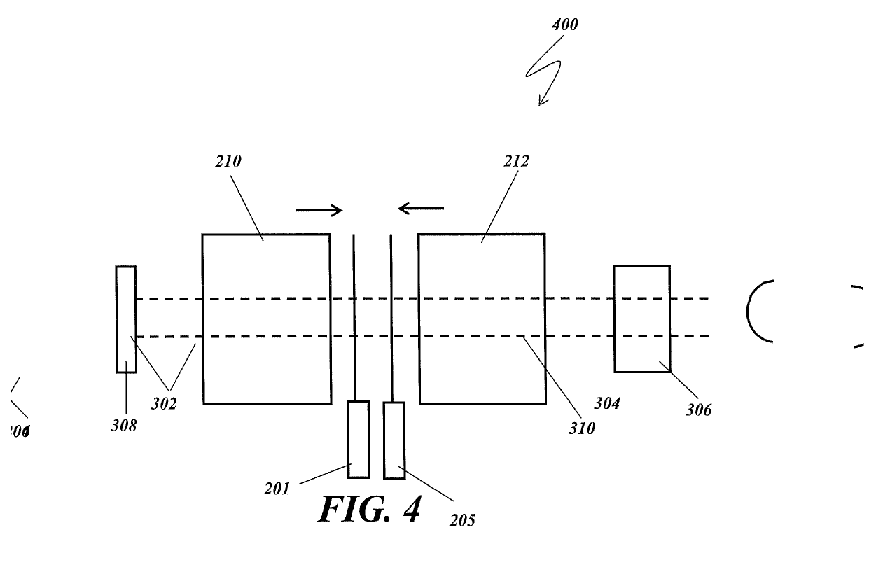

Turning now to FIG. 4, the connections between battery cells are made by compressing a foil tab for a negative terminal 204 for a first battery and a foil tab for a positive terminal 206 in a second battery between conductive elements 210 and 212 in a segment of a heat sink bus. The conductive elements of the heat sink bus compressively engage one positive foil tab and one negative foil tab for adjacent batteries in a battery module. The foil tabs have a relatively low power density connection such as a spot weld on one of the output terminals of a rechargeable battery cell. In one particular embodiment, the first battery foil tab has a different thermal conductivity and a different electrical conductivity than the second battery foil tab. The high power density elements have a relatively mass, a relatively high thermal conductivity and electrical conductivity compared to the positive foil tab. For purposes of this disclosure, in on embodiment, relative high is a factor of 100. For purposes of this disclosure, in another embodiment relatively high is a factor of 1000. For purposes of this disclosure, in another embodiment relatively high is a factor of 500.

In another particular embodiment, the high power density elements have a relatively high thermal conductivity and electrical conductivity compared to the negative foil tab. In a particular embodiment, the positive foil tab is made of copper and the negative foil tab is made of aluminum. In another particular embodiment, the high power density clamping elements are made of copper. In another particular embodiment, the mass of each segment of copper heat sink electrical bus elements is about 100 times the mass of a positive or negative foil tab. In another particular embodiment, the power density capacity of each segment copper element of the heat sink electrical bus is about 100 times greater than the power density capacity of one of the positive or negative foil tabs. In another particular embodiment, the mass of each segment of copper elements about 1000 times the mass of a positive or negative foil tab. In another particular embodiment, the power density capacity of each segment copper elements about 1000 times greater than the power density capacity of one of the positive or negative foil tabs. In another embodiment, the heat sink electrical bus in made of aluminum. In another embodiment, the heat sink electrical bus is made of steel.

High power density clamping elements are compressed together by tightening bolt 304 and nut 306 and bolt head 308. The tightening bolt runs through the high power density clamping elements and compresses curved washers 304 and 302 which lock the tightening bolt in place. In a particular illustrative embodiment, the curved washers are Bellville washers.

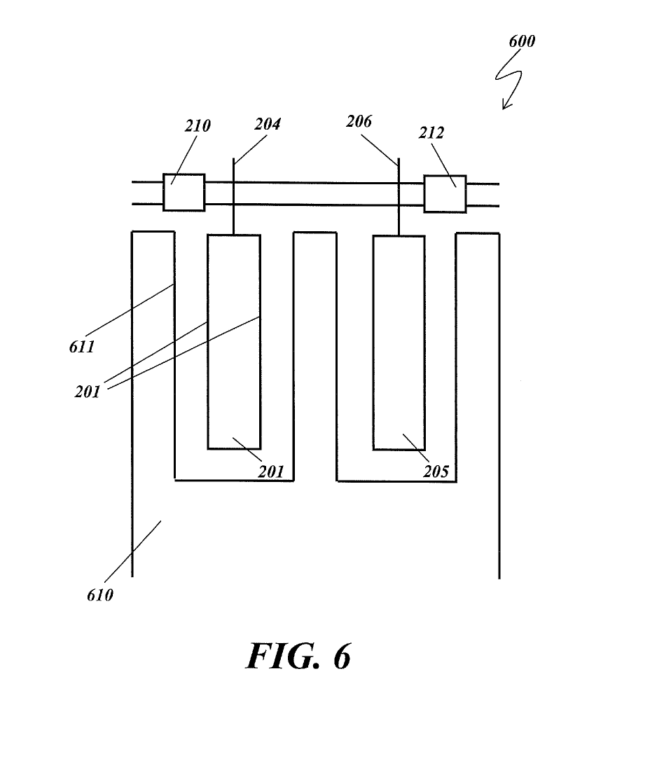

Turning now to FIG. 5, the conductive elements 209, 210, 212 and 213 are grouped in to sets of four elements to form a segment of four elements. The four segments shown for example in FIG. 5, are each separated by an insulator 301, 302, 303 and 304 respectively. Turning now to FIG. 6, each of the battery cells 201 and 203 are cooled by a bonded fin heat sink 610. In a particular embodiment, the bonded fin heat sink is liquid cooled. The side surfaces 611 and 612 of the bonded fin heat sink contact the hot outer side surfaces of each of the battery cells. The foil tab connectors 204 and 206 are compressed together between elements 210 and 212 of the high power density clamp. In an illustrative embodiment the heat sink bus is made of copper elements, the positive battery foil tab terminals are made of copper and negative foil battery terminals are made of tin plated aluminum.

In one particular embodiment, a method is disclosed for connecting batteries, the method including but not limited to clamping a hot battery terminal made of a first metal of a first battery cell to a cold battery terminal made of a second metal of a second battery cell, wherein the hot terminal has a lower thermal conductivity than the hot terminal; sharing heat from the hot and cold terminal in the clamp; dissipating the heat from the hot and cold terminal in the clam; and providing a higher power density from the batteries. In another particular embodiment, the hot terminal is made of aluminum and the cold terminal is made of copper. In another particular embodiment, the clamp is made of copper. In another particular embodiment, the method further includes clamping the hot terminal and the hot terminal together between copper sections of the using a Bellville washer. In another particular embodiment, the method further includes dissipating heat from the first battery cell body and the second battery cell body via a bonded fin heat sink in physical contact with the body of the first and second battery cell. In another particular embodiment, the hot positive terminal and the cold terminal are both foil members spot welded to the battery body.

In another embodiment, an apparatus is disclosed, the apparatus including but not limited to a plurality of battery cells; a positive terminal and a negative terminal for each of the plurality of battery cells; and a high power density clamp having a highly conductive mass for compressing the positive terminal for a first one of the plurality of batteries to the negative terminal of another one of the plurality of batteries into thermal and electrical communication. In another particular embodiment, the apparatus further includes but is not limited to a bonded fin heat sink in thermal communication with a first and second side of each one of the plurality of battery cells for transferring heat from the battery cell. In another particular embodiment, the apparatus further includes but is not limited to a curved washer for mechanically fixing a bolt running through the high power density clamp. In another particular embodiment of the apparatus the positive terminal further includes but is not limited to a tin plated aluminum foil member connected to the positive terminal of the first one of the battery cells and a copper foil member connected to the negative terminal of the battery cell, wherein the high power density clamp increases the power density of the battery during an emergency backup energy discharge from the battery cell. In another particular embodiment, the battery cells are lithium ion batteries. In another particular embodiment, the high power density clamp is a 3000 amperes electrical bus. In another particular embodiment of the apparatus the high power density clamp acts as a heat sink for heat from the positive terminal of the first one of the plurality of battery cells and heat from the negative terminal of the second one on the plurality of battery cells.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for connecting batteries, the method comprising:
clamping a hot battery terminal made of a first metal of a first battery cell to a cold battery terminal made of a second metal of a second battery cell,
wherein the hot terminal has a lower conductivity than the hot terminal;
sharing heat from the hot and cold terminal in the clamp;
dissipating the heat from the hot and cold terminal in the clam; and
providing a higher power density from the batteries.

2. The method of claim 1, wherein the hot terminal is made of aluminum and the cold terminal is made of copper.

3. The method of claim 2, wherein the clamp is made of copper.

4. The method of claim 1, further comprising:
clamping the hot terminal and the hot terminal together between copper sections of the using a Bellville washer.

5. The method of claim 4, the method further comprising:
dissipating heat from the first battery cell body and the second battery cell body via a bonded fin heat sink in physical contact with the body of the first and second battery cell.

6. The method of claim 2, wherein the hot positive terminal and the cold terminal are both foil members spot welded to the battery body.

7.

8. An apparatus comprising:
a plurality of battery cells;
a positive terminal and a negative terminal for each of the plurality of battery cells; and
a high power density clamp having a highly conductive mass for compressing the positive terminal for a first one of the plurality of batteries to the negative terminal of another one of the plurality of batteries into thermal and electrical communication.

9. The apparatus of claim 8, the apparatus further comprising:
a bonded fin heat sink in thermal communication with a first and second side of each one of the plurality of battery cells for transferring heat from the battery cell.

10. The apparatus of claim 9, the apparatus further comprising:
a curved washer for mechanically fixing a bolt running through the high power density clamp.

11. The apparatus of claim 10, wherein the positive terminal further comprises a tin plated aluminum foil member connected to the positive terminal of the first one of the battery cells and a copper foil member connected to the negative terminal of the battery cell, wherein the high power density clamp increases the power density of the battery during an emergency backup energy discharge from the battery cell.

12. The apparatus of claim 11, wherein the battery cells are lithium ion batteries.

13. The apparatus of claim 12, wherein the high power density clamp is a 3000 amperes electrical bus.

14. The apparatus of claim 12 wherein the high power density clamp acts as a heat sink for heat from the positive terminal of the first one of the plurality of battery cells and heat from the negative terminal of the second one on the plurality of battery cells.
